(19) United States
(12) Patent Application Publication
(10) Pub. No.: US 2019/0218725 A1
(43) Pub. Date: Jul. 18, 2019

(54) RAIL PULLING SYSTEM AND METHOD OF USE

(71) Applicant: RJ-PULL TITE, LLC, Shreveport, LA (US)

(72) Inventors: Christopher ADAMS, Shreveport, LA (US); Monty WILLIAMS, Shreveport, LA (US)

(21) Appl. No.: 15/944,198

(22) Filed: Apr. 3, 2018

Related U.S. Application Data
(60) Provisional application No. 62/618,075, filed on Jan. 17, 2018.

(51) Int. Cl. E01B 29/29

(52) U.S. Cl. CPC E01B 29/29; E01B 29/46; B23B 2215/32

(57) ABSTRACT

A rail pulling system comprising a first and a second pin, a first and a second bolt, a first and a second threaded hole, and a first and a second receiving bore. A method of pulling rails comprising inserting a first pin through a first rail hole of a first rail, the first pin having a first receiving bore mount secured thereto; inserting a second pin through a second rail hole of a second rail, the second pin having a second receiving bore mount secured thereto; securing a first threaded hole mount onto the first pin; securing a second threaded hole mount onto the second pin; inserting a first bolt through a first receiving bore on the first receiving bore mount until the first bolt functionally engages with a second threaded hole on the second threaded hole mount; inserting a second bolt through a second receiving bore on the second receiving bore mount until the second bolt functionally engages with a first threaded hole on the first threaded hole mount; rotating the first bolt; and rotating the second bolt.

### CROSS REFERENCE TO RELATED APPLICATIONS/PRIORITY

The present invention claims priority to U.S. Provisional Patent Application No. 62/618,075 filed Jan. 17, 2018, which is incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### BACKGROUND

Abutting rails may separate due to use, shifting loads, or other factors. Various methods have been attempted to rejoin the separated abutting rails, but they bring associated drawbacks, including using large and or heavy apparatus that are difficult to transport, expensive to maintain and operate, and damages the tops of the rails. Yet failing to rejoin the separated rails may cause damage to cranes and machines transported on the rails. For the foregoing reasons, there is a pressing, but seemingly irresolvable need for an improved rail pulling system.

### SUMMARY

Wherefore, it is an object of the present invention to overcome the above mentioned shortcomings and drawbacks associated with the current technology. The present invention is directed to methods and apparatuses that satisfy the above shortcomings and drawbacks. The method and apparatus comprise a rail pulling system including a plurality of pins, a plurality of bolts, and a plurality of receiving bores and threaded holes.

The present invention also relates to joined rail systems and to a rail pulling system that sets the secured distance between two abutting rails.

The invention further relates to methods and devices related to a rail pulling system including a first and a second pin; a first and a second bolt; a first and a second threaded hole; and a first and a second receiving bore. Optional embodiments include wherein the first receiving bore is mounted onto the first pin, and the second receiving bore is mounted onto the second pin. Optional embodiments include wherein the first and second receiving bores are fixedly mounted onto the respective first and second pins. Optional embodiments include wherein the first and second receiving bores are fixedly mounted onto respective trailing ends of the first and the second pins. Optional embodiments include wherein the receiving bores further comprise substantially smooth inner surfaces defining receiving bore holes. Optional embodiments include a first and a second threaded hole mount that mounts the respective first and second threaded hole onto the respective first and second pin. Optional embodiments include wherein the first and the second threaded hole mount is shaped to removeably engaged with respective leading ends of the first and the second pins. Optional embodiments include wherein the threaded holes further comprise threaded inner surfaces defining threaded hole openings. Optional embodiments include wherein the receiving bores are shaped so as to allow a leading end of the bolts to pass through the receiving bores and to engage with a bolt head. Optional embodiments include wherein the threaded holes are shaped so as to functionally engage with a leading end of the bolts. Optional embodiments include wherein the pins have a cross section measuring 1 inch in diameter. Optional embodiments include wherein the bolts have a cross section measuring 1 inch in diameter. Optional embodiments include wherein the bolts further comprise a head shaped to be rotated by one of a bit and a socket. Optional embodiments include wherein the first and the second threaded holes further comprise respective first and second threaded hole mounts. Optional embodiments include wherein the first and the second threaded holes are of unitary construction with the respective first and second threaded hole mounts. Optional embodiments include wherein the first and the second receiving bores further comprise respective first and second receiving bore mounts. Optional embodiments include the first and the second receiving bores are of unitary construction with the respective first and second receiving bore mounts.

The invention additionally relates to devices and methods of pulling rails comprising inserting a first pin through a first rail hole of a first rail, the first pin having a first receiving bore mount secured thereto; inserting a second pin through a second rail hole of a second rail, the second pin having a second receiving bore mount secured thereto; securing a first threaded hole mount onto the first pin; securing a second threaded hole mount onto the second pin; inserting a first bolt through a first receiving bore on the first receiving bore mount until the first bolt functionally engages with a second threaded hole on the second threaded hole mount; inserting a second bolt through a second receiving bore on the second receiving bore mount until the second bolt functionally engages with a first threaded hole on the first threaded hole mount; rotating the first bolt; and rotating the second bolt. Optional embodiments include wherein the second pin is inserted in the second rail hole in an opposite direction as the first pin is inserted in the first rail hole.

The invention also further relates to methods and devices of rail pulling systems including a first and a second pin; a first and a second bolt; a first and a second threaded hole; a first and a second receiving bore; the first receiving bore is fixedly mounted onto a trailing end of the first pin via a first receiving bore mount, the second receiving bore is fixedly mounted onto a trailing end of the second pin via a second receiving bore mount; the receiving bores further comprise substantially smooth inner surfaces defining receiving bore holes; a first and a second threaded hole mount that mounts the respective first and second threaded hole onto the respective first and second pin; the first and the second threaded hole mount is shaped to removably engaged with respective leading ends of the first and the second pins; the threaded holes further comprise threaded inner surfaces defining threaded hole openings; the receiving bores are shaped so as to allow a leading end of the bolts to pass through the receiving bores and to engage with a bolt head; the threaded holes are shaped so as to functionally engage with a leading end of the bolts; the pins have a cross section measuring 1 inch in diameter; the bolts have a cross section measuring 1 inch in diameter; the bolts further comprise a head shaped to be rotated by one of a bit and a socket; the first and the second threaded holes are of unitary construction with the respective first and second threaded hole mounts; and the first and the second receiving bores are of unitary construction with the respective first and second receiving bore mounts.

It should be noted that the bolts, pins, nuts, and holes are not limited to the stated dimensions, nor a particular thread type or thread direction, including metric, standard, and the like.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 is a top plan view of a first embodiment of the rail pulling system according to the presently claimed invention in a disassembled state;

FIG. 2A is a side plan view of a threaded hole and threaded hole mount from FIG. 1, viewed along the direction of arrow marked F2A in FIG. 1;

FIG. 2B is a side plan view of the threaded hole and threaded hole mount from FIG. 2A, viewed along the direction of arrow marked F3A in FIG. 1;

FIG. 3 is a side plan view of a pin from FIG. 1, viewed along the direction of arrow marked F3 in FIG. 1;

FIG. 4 is a side plan view of two abutting rails with an excessive rail gap spacing the rails from one another;

FIG. 5 is a top plan view of the rail pulling system of FIG. 1 showing direction of insertion of the bolts and the two abutting rails shown in dashed lines to allow for the rail pulling system to be shown in detail;

FIG. 6 is a top plan view of the rail pulling system of FIG. 5 with the bolts inserted into the receiving bores and threaded holes and the two abutting rails again shown in detail;

FIG. 7 is a top plan view of the rail pulling system of FIG. 1 mounted on the two abutting rails of FIG. 4, with the rail pulling system in a partially engaged state;

FIG. 8 is a top plan view of the mounted rail pulling system of FIG. 7 in a near fully engaged state; ;

FIG. 9 is a side plan view of the mounted rail pulling system of FIG. 7 viewed along the direction of arrow marked F9 in FIG. 7;

FIG. 10 is a side plan view of the mounted rail pulling system of

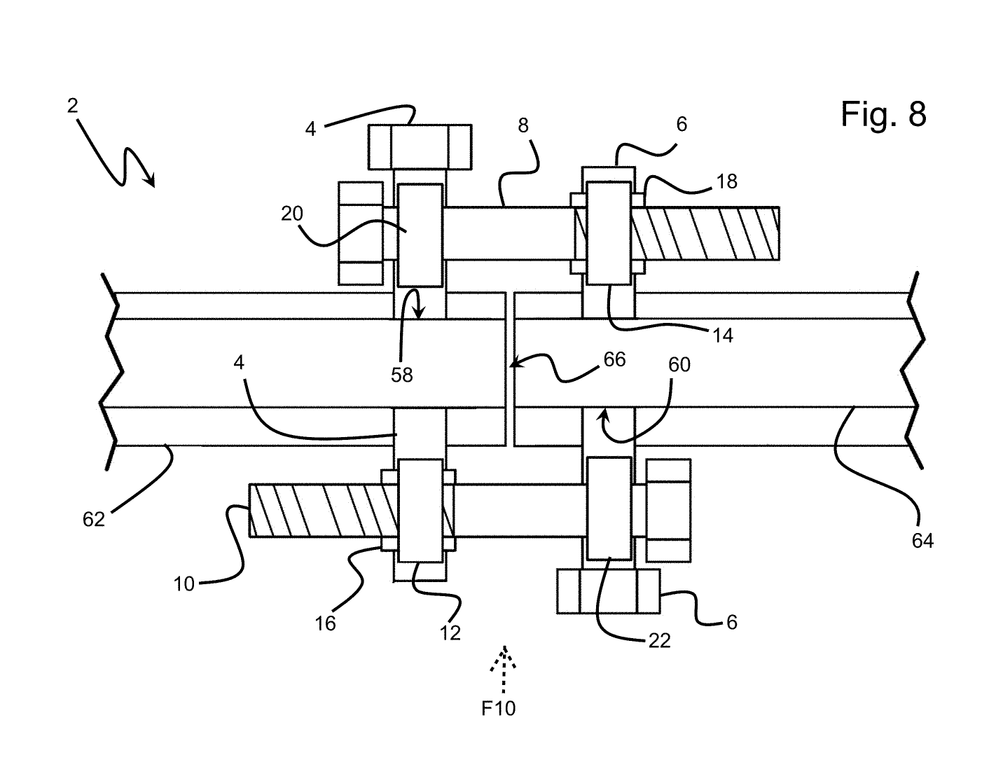

FIG. 8 viewed along the direction of arrow marked F10 in FIG. 8;

FIG. 11 is a flow chart of an method of pulling rails according to a further embodiment of the presently claimed invention;

FIG. 12 is a top plan view of a second embodiment of the rail pulling system according to the presently claimed invention in a disassembled state;

FIG. 13 is an isometric perspective view of the rail pulling system of FIG. 12, with the bolts omitted;

FIG. 14 is a partial sectional view of the pin of FIG. 12, showing the fastening aperture and the pin fastener;

FIG. 15A is a side plan view of one of the receiving bore mounts of the second embodiment as shown in FIG. 13;

FIG. 15B is a top plan view of the receiving bore mount of FIG. 15A;

FIG. 15C is a bottom plan view of the receiving bore mount of FIG. 15A;

FIG. 15D is a side plan view of the receiving bore mount of FIG. 15A in the same orientation as shown as the receiving bore mounts of FIG. 13;

FIG. 16A is a side plan view of one of the threaded hole mounts of the second embodiment as shown in FIG. 13;

FIG. 16B is a top plan view of the threaded hole mount of FIG. 16A;

FIG. 16C is a bottom plan view of the threaded hole mount of FIG. 16A; and

FIG. 16D is a side plan view of the threaded hole mount of FIG. 16A in the same orientation as shown as the threaded hole mounts of FIG. 13.

### DETAILED DESCRIPTION

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. The embodiments set forth the below represent the necessary information to enable those skilled in the art to practice the invention and illustrate the best mode of practicing the invention. In addition, the invention does not require that all the advantageous features and all the advantages need to be incorporated into every embodiment of the invention.

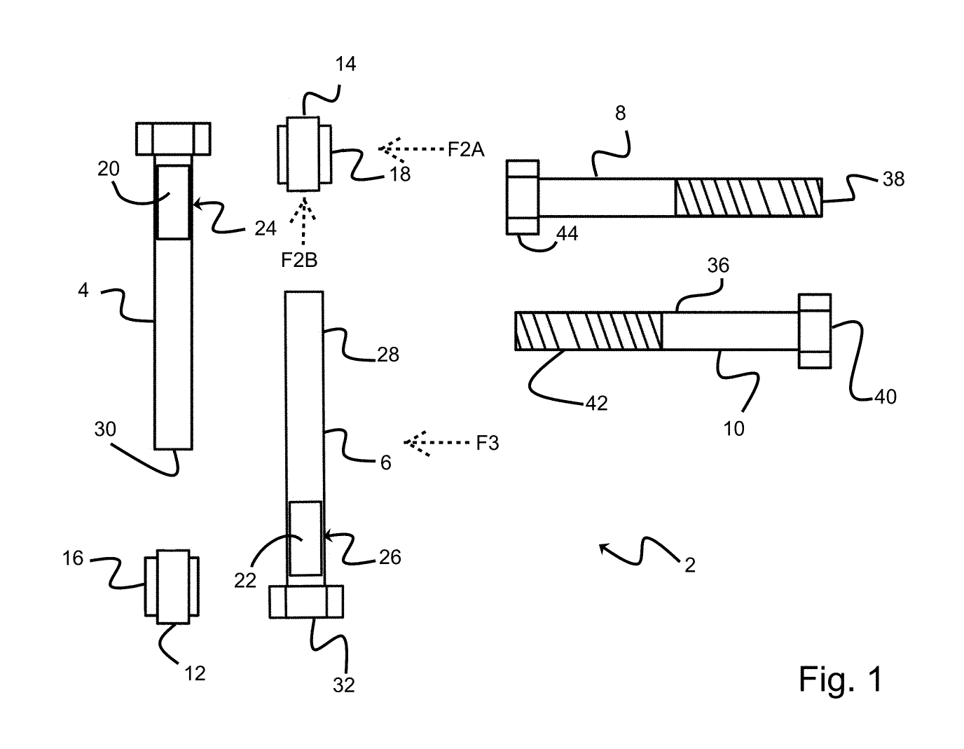

Turning now to FIGS. 1-3, a brief description concerning the various components of the present invention will now be briefly discussed. As can be seen in this embodiment, the rail pulling system 2 includes a first and a second pin 4, 6, a first and a second bolt 8, 10, a first and a second threaded hole 12, 14, mounted on respective first and second threaded hole mounts 16, 18, and first and second receiving bores 20, 22 mounted on respective first and second receiving bore mounts 24, 26.

The first and second pin 4, 6 are elongate, and preferably cylindrical in shape, defining a pin shaft 28 with a pin leading end 30 on one end of the pin shaft 28 and a pin trailing end 32 on an opposing end of the pin shaft 28. The pin leading end 30 preferably has a constant radius with the pin shaft 28 and a smooth exterior surface, though the exterior surface may be threaded in some embodiments. The pin trailing end 32 preferably has an enlarged pin head 34 with a radius larger than the pin shaft 28, as shown, though the pin trailing end 32 may have a constant radius with a smooth or threaded exterior surface in some embodiments. The pin head 34, when present, is preferably unitary of construction with the pin shaft 28. In the embodiment shown, the pin shaft 28 has a circular cross section, though in further embodiments, the pin shaft 28 may have a square, hexagonal, pentagon, triangular, or other non-circular cross section. Such a non-circular cross sectioned pin shaft 28 would offer benefits, especially when paired with a matingly non-circular threaded hole mount 16, 18.

The pins 4, 6 are preferably sized between 0.25 and 2 inches in diameter and between 5 and 10 in length, and are most preferably sized ⅞ inches in diameter and 7 inches in length. The pins 4 ,6 are preferably formed of 4140 steel, but may also be formed of grade 8 or other steels, or other metals, including pure metals and alloys.

The first and second bolts 8, 10 are elongate and cylindrical, defining a bolt shaft 36 with a bolt leading end 38 on one end of the bolt shaft 36 and bolt trailing end 40 on an opposing end of the bolt shaft 36. A threaded portion 42 of the bolt shaft 36 preferably extends from the bolt leading end 38 approximately half the length of the bolt shaft 36 toward the bolt trailing end 40. The threaded portion 42 of the bolt shaft 36 may extend less than half of the length of the bolt shaft 36, or may extend greater than half the length of the bolt shaft 36, and may extend substantially the entire length of the bolt shaft 36. At the bolt shaft trailing end 40 is preferably an enlarged bolt head 44 with a diameter larger than the bolt shaft 36. The bolt head 44, when present, is preferably unitary of construction with the bolt shaft 36, and preferably shaped to functionally engage with and be rotated by a bit or socket.

In a further embodiment, the bolt head 44 may be formed by one or more nuts threaded onto a threaded portion 42 of the bolt trailing end 40.

Additionally, in a further embodiment, the threaded hole 12, 14 may be formed by a nut exterior axially aligned with but on an opposite side of a smooth threaded hole opening 48 from the advancing direction of the leading ends 38 of the first and second bolts 8, 10, such that the leading ends 38 of the bolts 8, 10 must first pass through the smooth threaded hole openings 48 before functionally engaging with the nuts.

The bolts 8, 10 are preferably sized between 0.25 inches and 2 inches in diameter and between 5 inches and 10 inches in length, and are most preferably sized ⅞ inches in diameter and 7 inches in length. The bolts 8, 10 are preferably formed of 4140 steel, but may also be formed of grade 8, other steels, or other metals, including pure metals and alloys

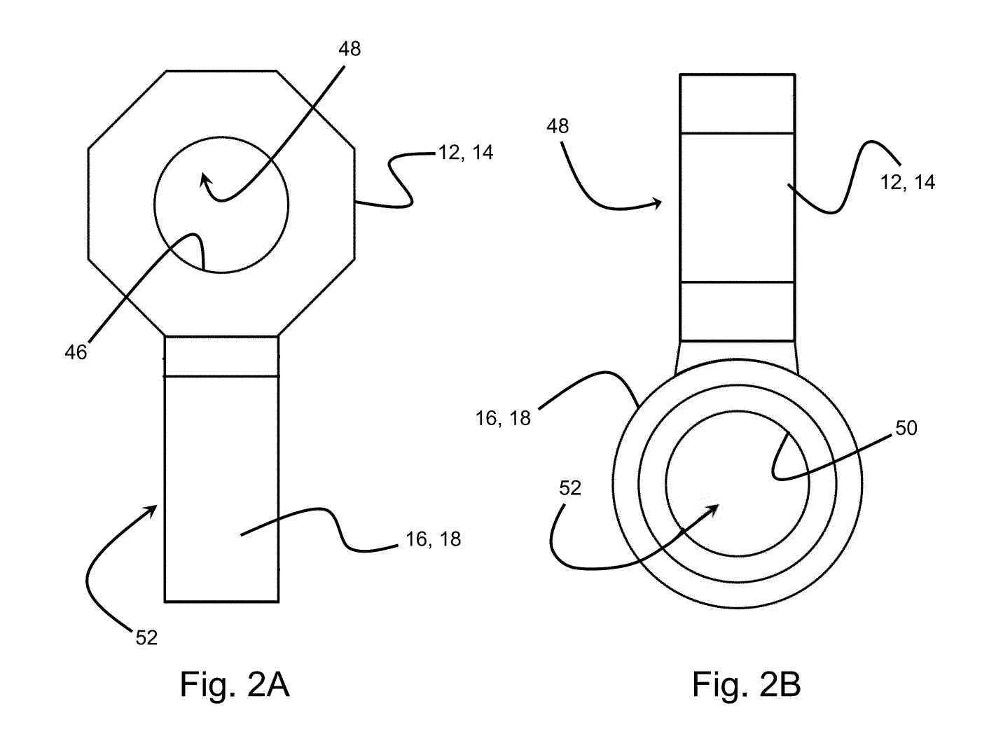

Turning next to FIGS. 2A and 2B, the first and the second threaded hole 12, 14 are mounted on respective first and second threaded hole mounts 16, 18. A threaded inner surface 46 of the threaded holes 12, 14 define a threaded hole opening 48 sized to receive and functionally engage the threaded portions 42 of the bolt shafts 36. In the embodiment shown, the threaded holes 12, 14 are fixedly connected to the threaded hole mounts 16, 18. A THM inner surface 50 of the threaded hole mounts 16, 18 define a THM opening 52 that is sized and shaped to receive the leading end of the pin 4, 6 with preferably a clearance or location/transition fit. The first and the second treaded hole 12, 14 and the first and the second threaded hole mounts 16, 18 are preferably made of 4140 steel, but may also be formed of Grade 8, other steels and other metals, including pure metals and alloys. The first and the second threaded holes 12, 14 are preferably of unitary construction with the respective first and second threaded hole mounts 16, 18. In the embodiment shown, both the threaded hole opening 48 and the THM opening 52 are through holes. In other embodiments, the THM opening 52 may be a bore that only partially extends through the threaded hole mount 16, 18.

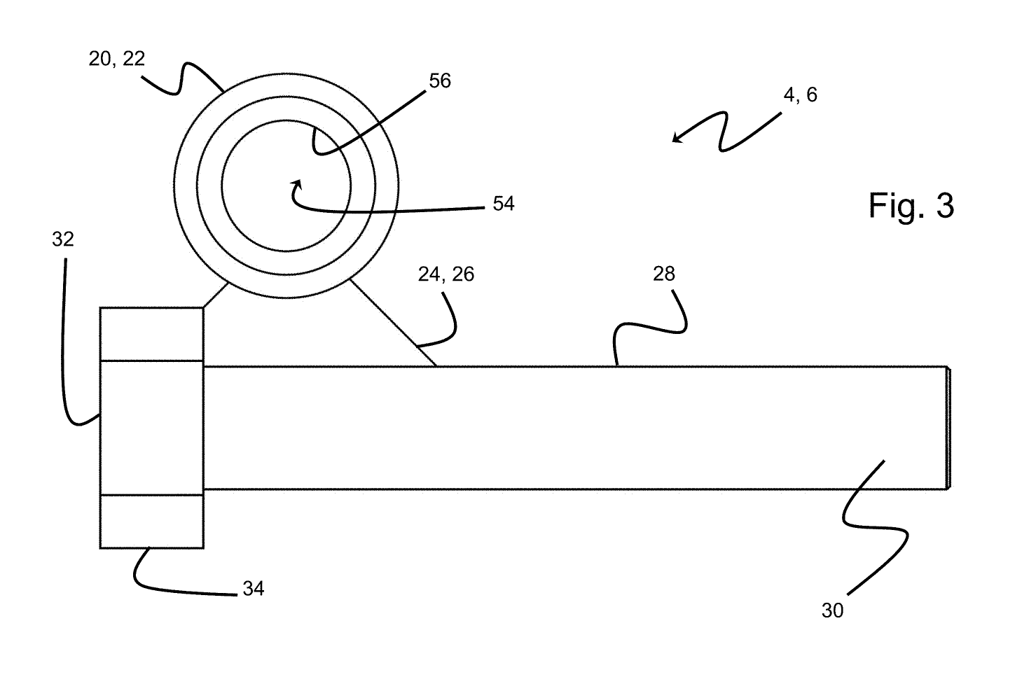

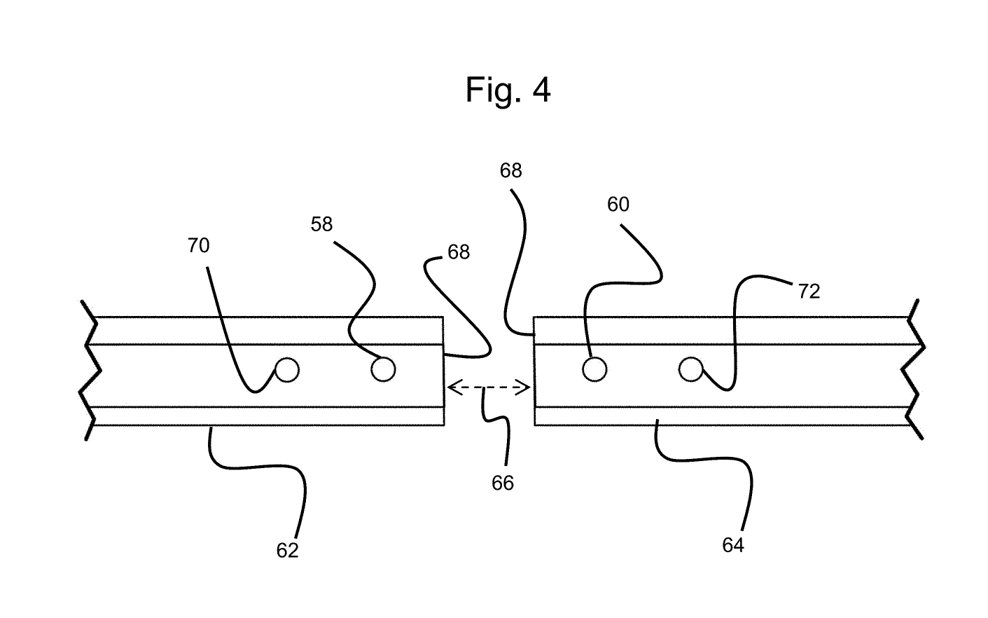

Turning to FIG. 3, the first and the second receiving bore 20, 22 are shown mounted on the respective first and second receiving bore mount 24, 26. A preferably smooth RB inner surface 56 defines a RB opening 54 that is sized to receive the bolt leading end 38 with a clearance or location/transition fit. The first and second receiving bore mounts 24, 26 are themselves attached to the respective first and the second pins 4, 6. In the embodiment shown, the receiving bore mounts 24, 26 are fixedly attached to the respective pins 4, 6 at a location adjacent to the trailing end 32 of the pin shaft 28 and the pin head 34. This allows for quick and secure use of the pin 4, 6 and receiving bore 20, 22 when using the rail pulling system 2. In alternative embodiments, the receiving bore mount 24, 26 may be formed similar to the threaded hole mount 16, 18, such that the alternative embodiment receiving bore mount 24, 26 may slide on the pin leading end 30, down the pin shaft 28, to the pin head 34 before the pin 4, 6 is inserted into one of a first or a second rail hole 58, 60 of in a respective first or second rail 62, 64. Or, in the absence of a pin head 34, the alternative embodiment receiving bore mount 24, 26 may be slid directly on to the pin trailing end 32 before or after the pin 4, 6 is inserted into a rail hole 58, 60.

Though in the embodiment shown, each pin 4, 6 supports one treaded hole mount 16, 18 and one receiving bore mount 24, 26, in further embodiments, one pin 4, 6 may support two threaded hole mounts 16, 18 and the other pin 4, 6 may support two receiving bore mounts 20, 22. Such an embodiment would potentially increase production costs, but would offer a benefit of actuating both bolts 8, 10 from the same direction, which saves time and energy and cost in the rail pulling process.

Turning to FIG. 4, abutting first and second rails 62, 64 are shown. In the arrangement shown, the rail gap 66, defined by the distance between the two abutting rail ends 68, is greater than a desired rail gap 66. In the preferred embodiment the desired rail gap is 0 mm or substantially 0 mm, including where the two abutting rail ends are directly in contact with one another. Four rail holes or apertures are shown 58, 60, 70, 72, first and third rail holes 58, 70 in the first rail 62 and second and fourth rail holes 60, 72 in the second rail 64.

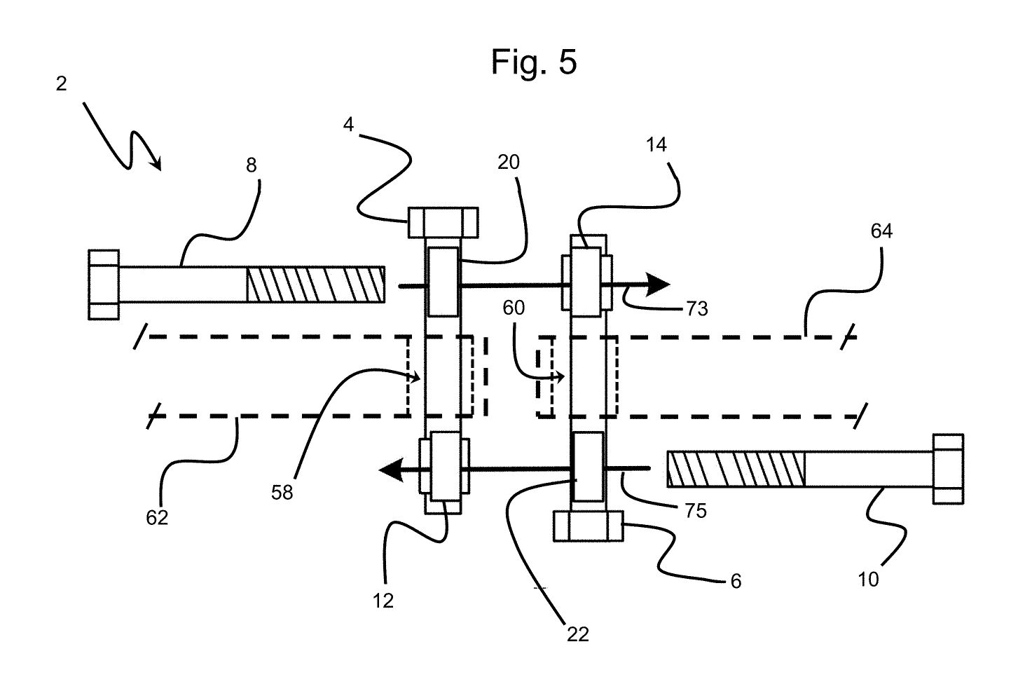

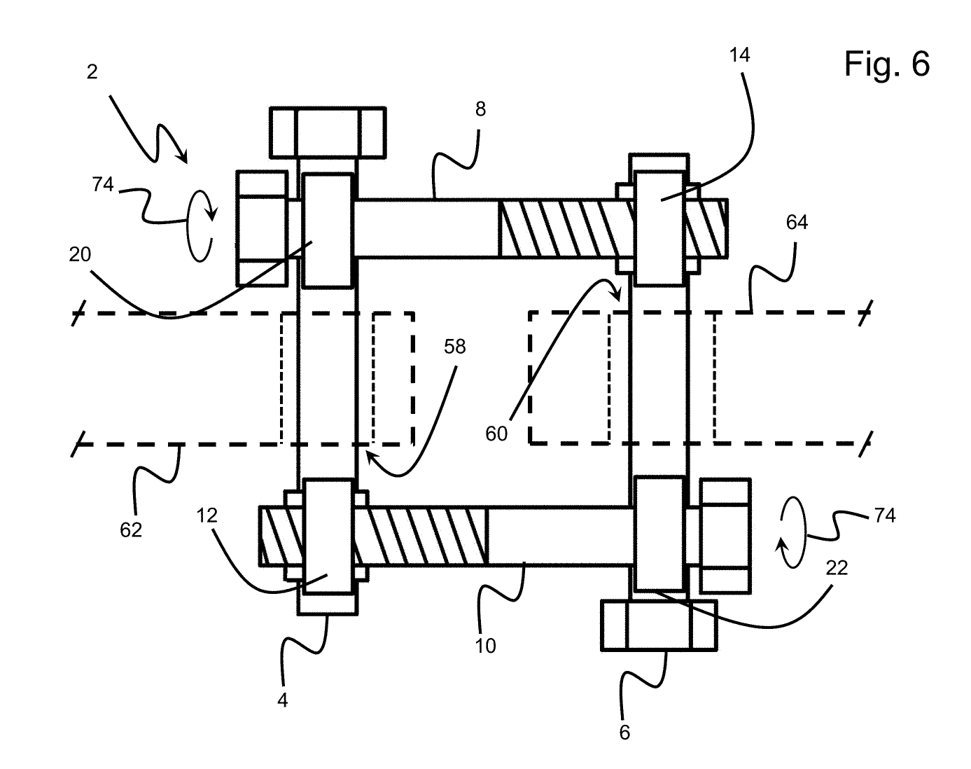

Turning also to FIG. 5, the rail pulling system 2 is shown in preparation for engagement. The rails 62, 64 are only displayed with hash marks, so as to show the rail pulling system 2 in greater detail. The first pin 4 is inserted through the first rail hole 58 on the first rail 62 and the second pin 6 is inserted from the opposite direction through the second rail hole 60 on the second rail 64. The threaded hole mounts 16, 18 are mounted onto the pin leading ends 30. Either sequentially or simultaneously, the bolt leading ends 38 of the first and the second bolts 8, 10 are then inserted through the RB openings 56 of the respective first and second receiving bores 20, 22 in the first and second bolt insertion direction 73, 75, and insertion is continued until the bolts 8, 10 engage with the respective first and second threaded holes 12, 14. As shown in FIG. 6, once engaging with the respective threaded holes 12, 14, the first and second bolts 8, 10 are rotated 74, for example in a clockwise direction, preferably by a bit or socket wrench, to advance the bolt leading ends 38 into and through the respective first or second threaded holes 12, 14. In other embodiments, the bolts 8, 10 and threaded holes 12, 14 may be threaded such that the direction of rotation 74 is counter clockwise to engage the rail pulling system 2.

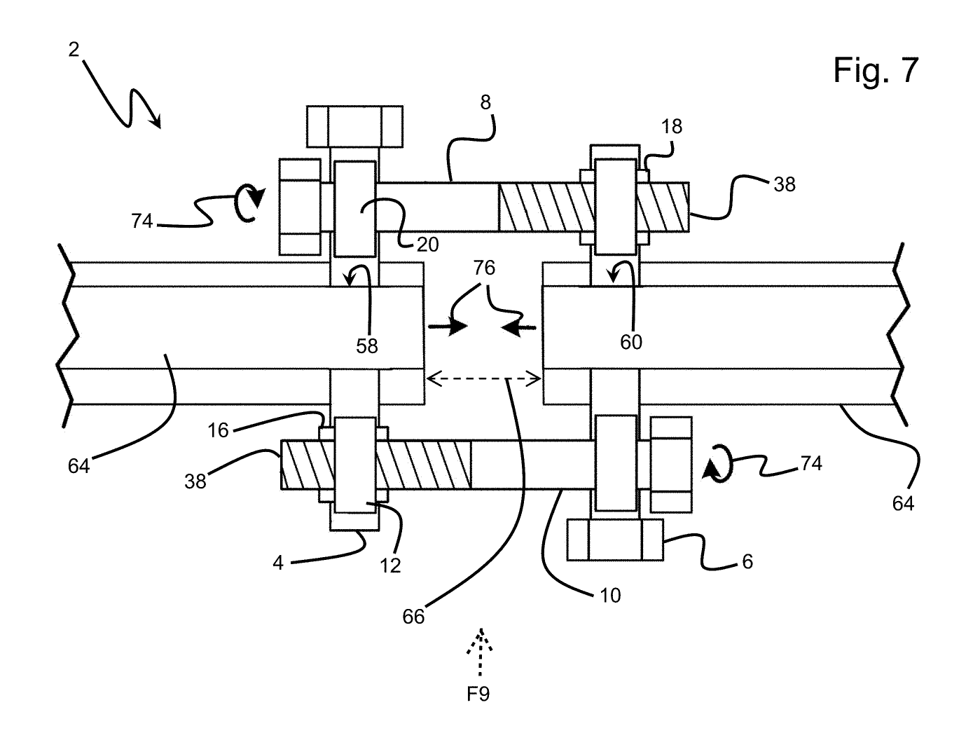

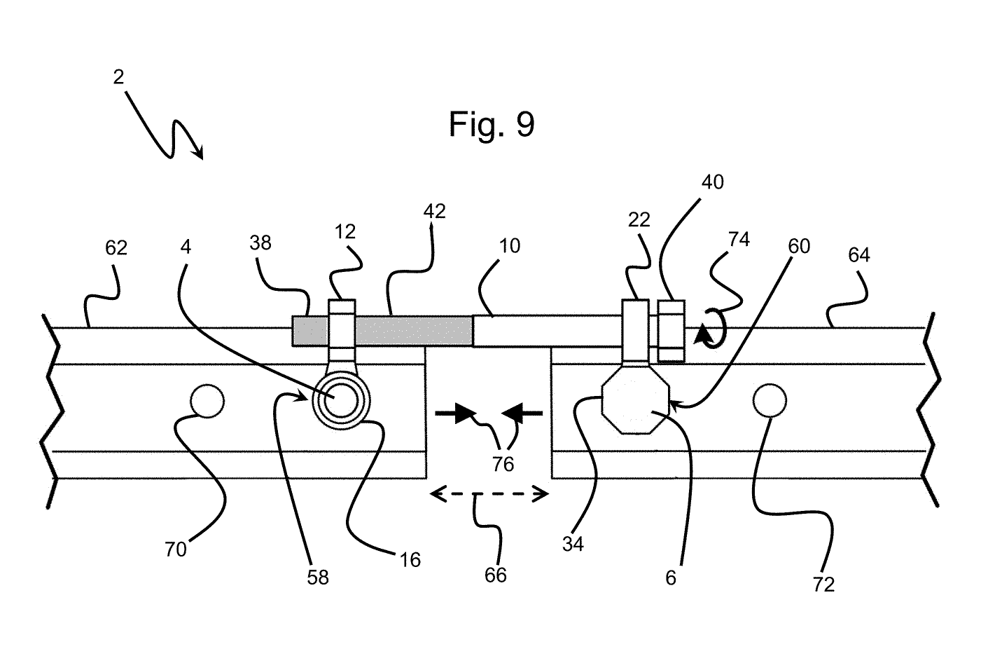

Turning to FIGS. 7 and 9, the rail pulling system 2 is shown in a partially engaged state, as in FIG. 6, but with the rails shown in solid lines. Starting with the bottom portion of FIG. 7, as the second bolt 10 is rotated 74, the rotation motion of the second bolt 10 causes the threaded portion 42 to engage with the TH threaded inner surface 46 of the first threaded hole 12. This pulls the first threaded hole 12 in the direction of the bolt trailing end 40 on the second bolt 10 (to the right of FIG. 7). This causes the first threaded hole 12 to pull the first threaded hole mount 16 and the pin shaft 28 adjacent to the leading end 30 of the first pin 4 toward the bolt trailing end 40 on the second bolt 10. In response, the bolt head 44 on the second bolt 10 exerts force on the second receiving bore 22 in the direction of the bolt leading end 38 of the second bolt 10 (to the left of FIG. 7). This force is transferred from the second receiving bore 22 through the second receiving bore mount 26 to the second pin 6, causing the pin trailing end 32 of the second pin 6 to be urged in the direction of the pin leading end 30 of the first pin 4. This causes the rails move toward one another 76 in the direction indicated.

Continuing with the top portion of FIG. 7, as the first bolt 8 is rotated 74, the rotation motion of the first bolt 8 causes the threaded portion 42 to engage with the TH threaded inner surface 46 of the second threaded hole 14. This pulls the second threaded hole 14 in the direction of the bolt trailing end 40 on the first bolt 8 (to the left of FIG. 7). This causes the second threaded hole 14 to pull the second threaded hole mount 18 and the pin shaft 28 adjacent to the leading end 30 of the second pin 6 toward the bolt trailing end 44 on the first bolt 8. In response, the bolt head 44 on the first bolt 8 exerts force on the first receiving bore 20 in the direction of the bolt leading end 38 of the first bolt 8 (to the right of FIG. 7). This force is transferred from the first receiving bore 20 through the first receiving bore mount 24 to the first pin 4, causing the pin trailing end 32 of the first pin 4 to be urged in the direction of the pin leading end 30 of the second pin 6.

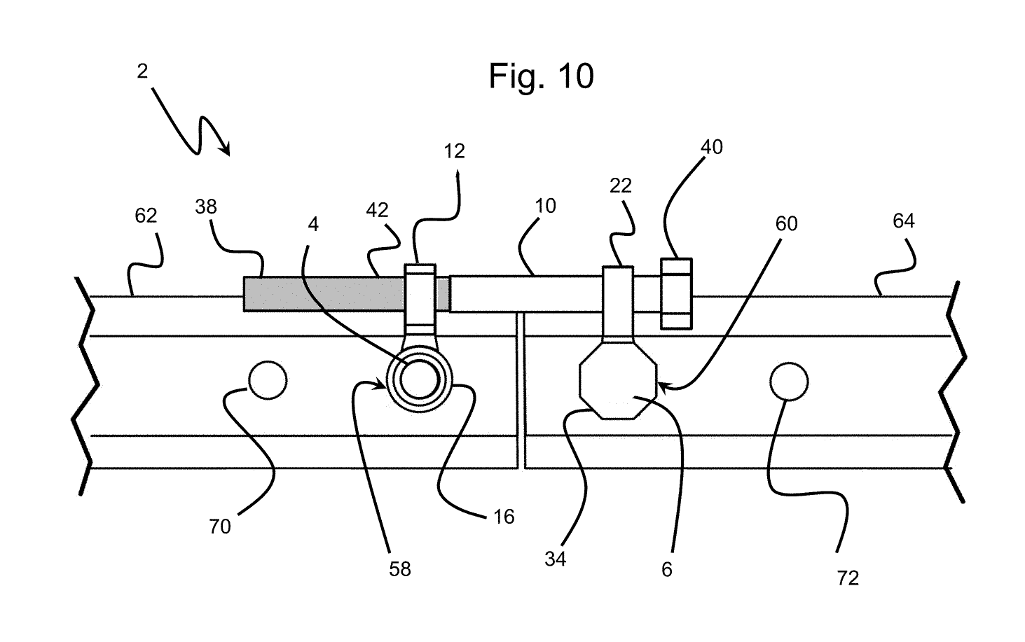

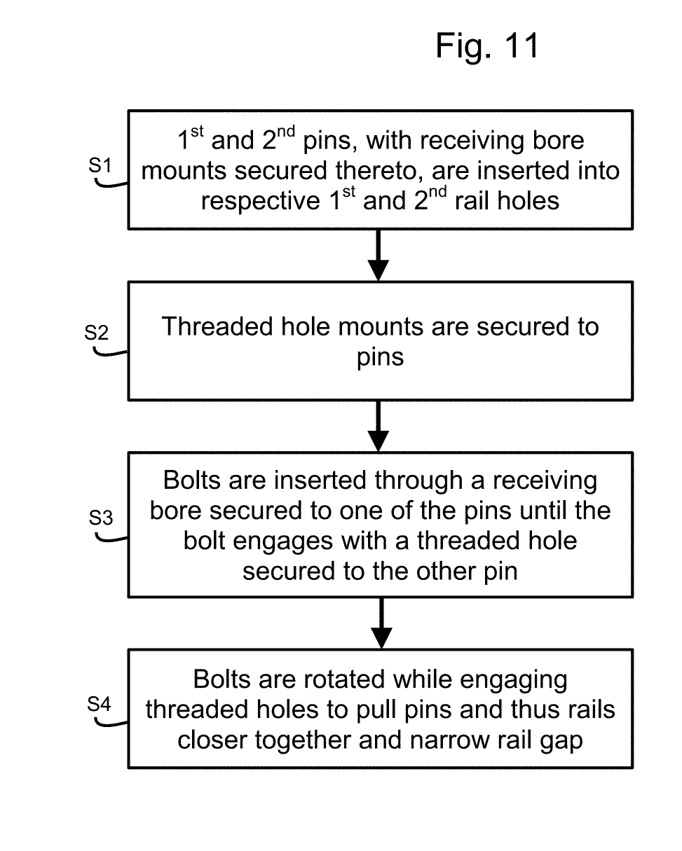

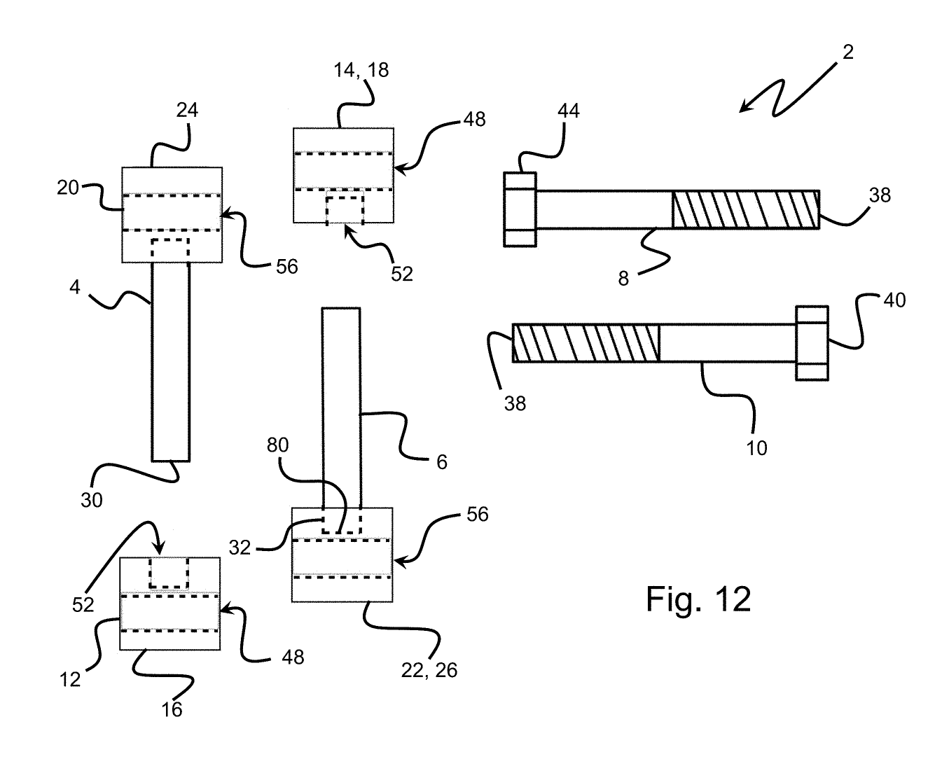

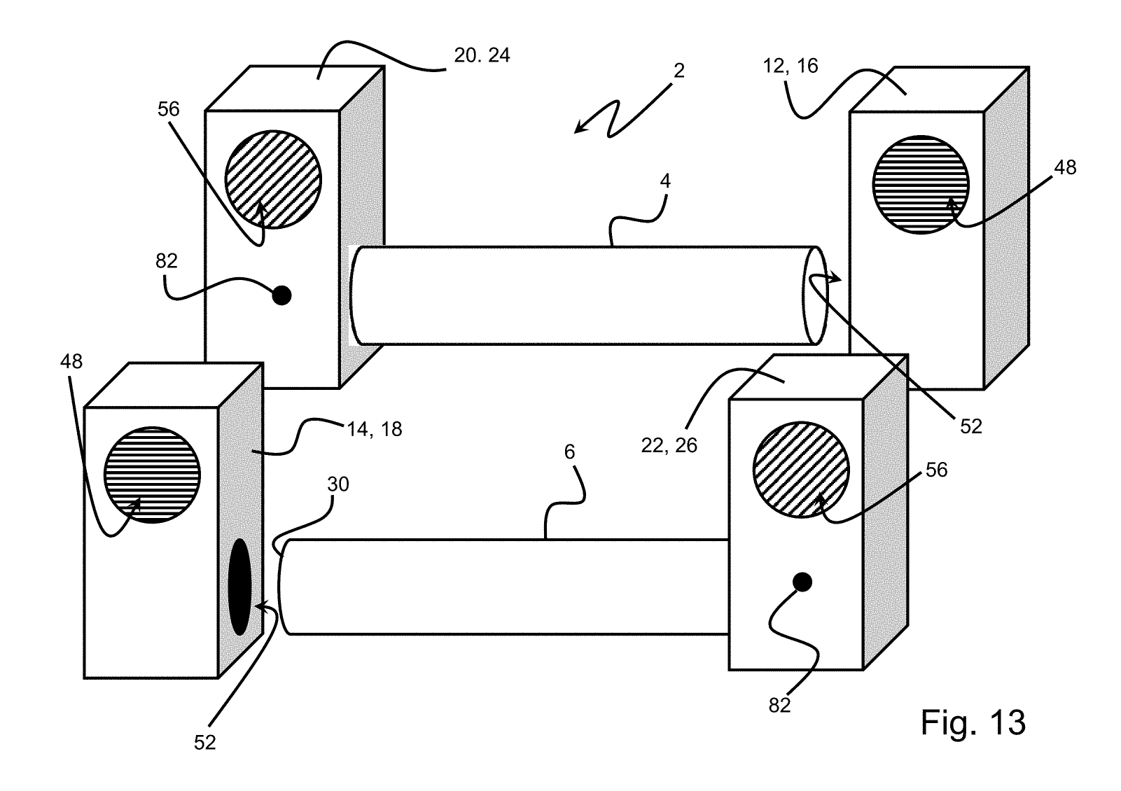

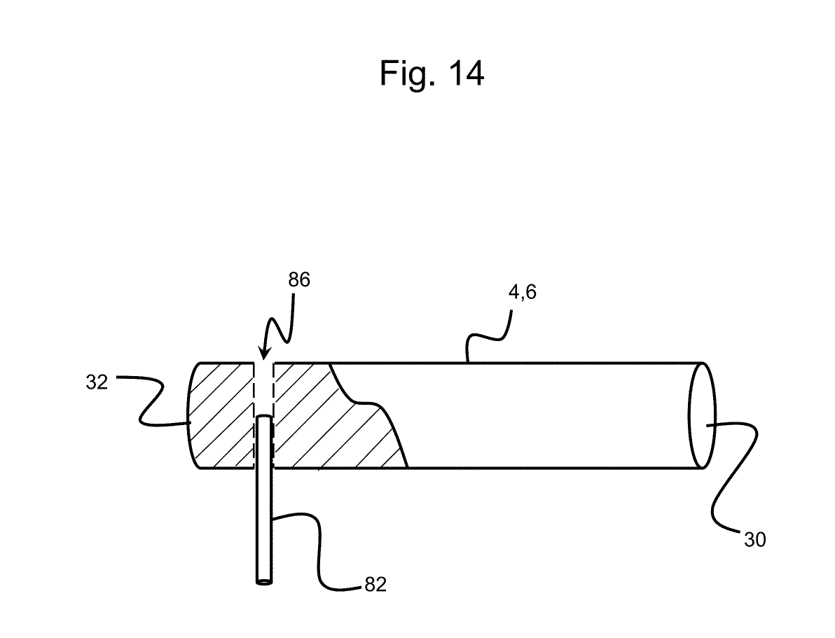

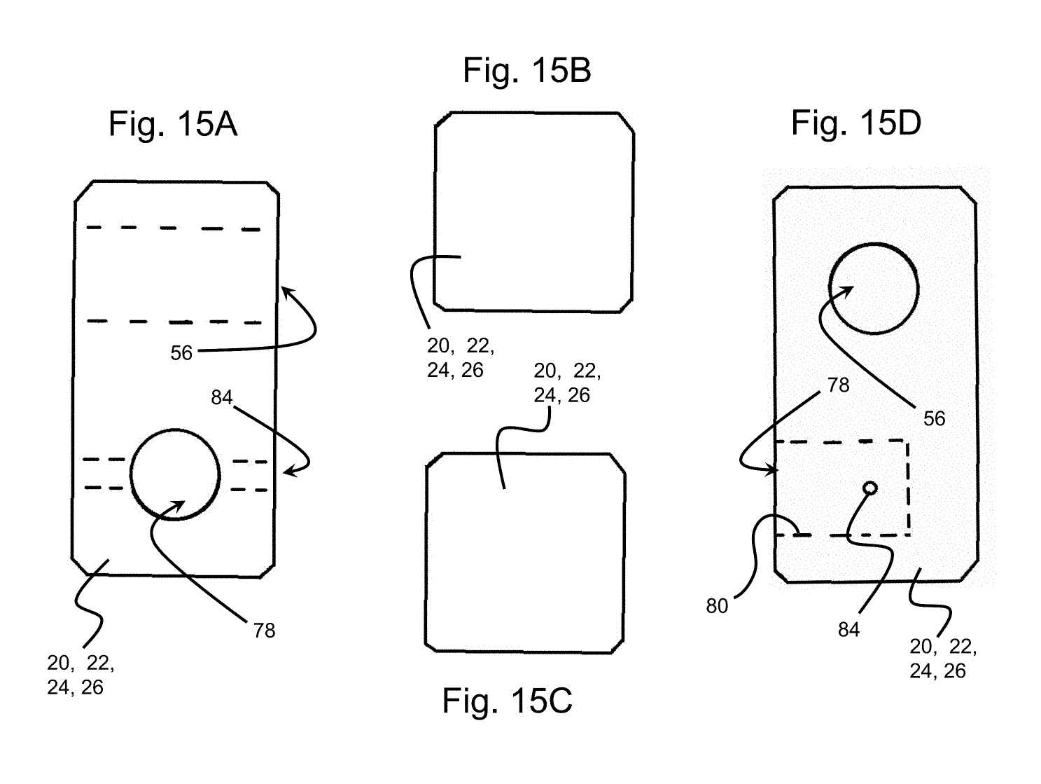

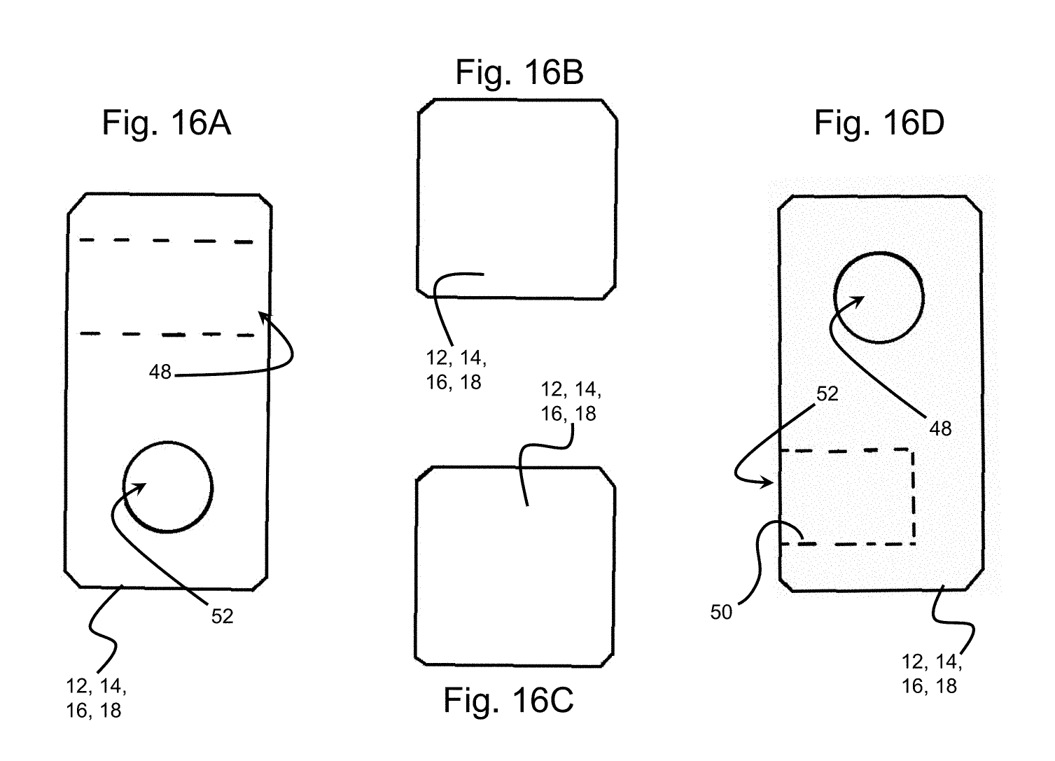

As the pin trailing end 32 of the first pin 4 is urged toward the pin leading end 30 of the second pin 6, and the pin leading end 30 of the first pin 4 is urged toward to pin trailing end 32 of the second pin 6, the first pin 4, in the first rail hole 58 of the first rail 62, pulls 76 the first rail 62 towards the second pin 6 (to the right of FIG. 7) and the second pin 6, in the second rail hole 60 of the second rail 64, pulls 76 the second rail 64 toward the first pin 4 (to the left in FIG. 7). This combined force causes the two rails 62, 64 to move toward one another 76 and decrease the rail gap 66. Rotation 74 of the first and second bolts 8, 10 preferably continues until the rail gap 66 has decreased below a desired maximum rail gap 66, such as 50, 100, or 200 mm, for example, as shown in FIGS. 8 and 10. The rail gap 66 may also be decreased to substantially 0 mm, such that the abutting rail ends 68 of the rails 62, 64 are in direct contact with one another.

The bolts 8, 10 are preferably rotated 74 sequentially, first one 8, 10 then the other 8, 10, for a length of time that partial advances the bolt leading end 38 through the threaded hole 12, 14, then repeated for multiple rounds. This allows the rails 62, 64 to remain aligned, or regain alignment, as the rails 62, 64 are moved toward one another 76 and the rail gap 66 is decreased. Alternatively, the bolts 8, 10 may be rotated 74 simultaneously at the same, or near same speed, so that the rails 62, 64 may be moved toward one another while remaining aligned or regaining alignment.

Turning to FIG. 11, another aspect of the disclosed invention is one embodiment of the method to move rails 62, 64 back together using the rail pulling system 2. In step S1, the first and the second pins 4, 6, with receiving bore mounts 24, 26 secured onto the respective pins 4, 6, are inserted into respective first and second rail holes 58, 60. In step S2, the first and second threaded hole mounts 16, 18 are secured onto the respective first and second pins 4, 6. In step S3, the first and the second bolts 8, 10 are inserted through the respective first and second receiving bores 20, 22, which are secured to respective first and second pins 4, 6, until the bolts 8, 10 engage with respective second and first threaded holes 12, 14 secured to respective second and first pins 4, 6. In step S4, the first and second bolts 8, 10 are rotated 74 while functionally engaging with the respective second and first threaded holes 12, 14 to pull both pins 4, 6 and thus both rails 62, 64 closer together 76 and narrow the rail gap 66 until a desired separation is attained, which in the preferred embodiment is substantially 0 mm.

Turning now to FIGS. 12-16, an additional embodiment of the rail pulling system 2 is shown. In this embodiment, the first and second threaded hole mounts 16, 18 and the first and second receiving bore mounts 24, 26 are each larger, substantially solid rectangular prisms. The design allows for faster manufacture of the mounts 16, 18, 24, 26. Also, the preferably increased length of the RB openings 56 and the threaded hole openings 48 in this embodiment allow for increased lateral engagement between the bolt shaft 36 and each of the RB inner surface 54 and TH threaded inner surface 46, thereby decreasing the torque exerted on the receiving bores 20, 22 and threaded holes 12, 14 when the bolts 8, 10 are functionally engaged and turning 74.

In one optional aspect of the embodiment shown in FIGS. 12-16, the pin 4, 6 is matingly received in an RBM opening 78, defined by an RBM inner surface 80, and secured therein with a peg 82. The peg 82 extends through both an RBM peg hole 84 and a pin peg hole 86 to fasten and secure the pin 4, 6 to the receiving bore mount 24, 26. The peg preferably extends substantially the full length of the RBM peg hole 84. The peg 82 may be frictionally secure, soldered, glued, welded, screwed, and/or riveted, for example. Other chemical and physical methods of fastening the pin 4, 6, to the receiving bore mount 24, 26 may additionally or alternatively be used.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

Wherefore, we claim:

1. A rail pulling system comprising:
a first and a second pin;
a first and a second bolt;
a first and a second threaded hole; and
a first and a second receiving bore.

2. The rail pulling system of claim 1 wherein the first receiving bore is mounted onto the first pin, and the second receiving bore is mounted onto the second pin.

3. The rail pulling system of claim 1 wherein the first and second receiving bores are fixedly mounted onto the respective first and second pins.

4. The rail pulling system of claim 1 wherein the first and second receiving bores are fixedly mounted onto respective trailing ends of the first and the second pins.

5. The rail pulling system of claim 1 wherein the receiving bores further comprise substantially smooth inner surfaces defining receiving bore holes.

6. The rail pulling system of claim 1 further comprising a first and a second threaded hole mount that mounts the respective first and second threaded hole onto the respective first and second pin.

7. The rail pulling system of claim 6 wherein the first and the second threaded hole mount is shaped to removably engaged with respective leading ends of the first and the second pins.

8. The rail pulling system of claim 1 wherein the threaded holes further comprise threaded inner surfaces defining threaded hole openings.

9. The rail pulling system of claim 1 wherein the receiving bores are shaped so as to allow a leading end of the bolts to pass through the receiving bores and to engage with a bolt head.

10. The rail pulling system of claim 1 wherein the threaded holes are shaped so as to functionally engage with a leading end of the bolts.

11. The rail pulling system of claim 1 wherein the pins have a cross section measuring 1 inch in diameter.

12. The rail pulling system of claim 1 wherein the bolts have a cross section measuring 1 inch in diameter.

13. The rail pulling system of claim 1 wherein the bolts further comprise a head shaped to be rotated by one of a bit and a socket.

14. The rail pulling system of claim 1 wherein the first and the second threaded holes further comprise respective first and second threaded hole mounts.

15. The rail pulling system of claim 14 wherein the first and the second threaded holes are of unitary construction with the respective first and second threaded hole mounts.

16. The rail pulling system of claim 1 wherein the first and the second receiving bores further comprise respective first and second receiving bore mounts.

17. The rail pulling system of claim 16 wherein the first and the second receiving bores are of unitary construction with the respective first and second receiving bore mounts.

18. A method of pulling rails comprising:
inserting a first pin through a first rail hole of a first rail, the first pin having a first receiving bore mount secured thereto;
inserting a second pin through a second rail hole of a second rail, the second pin having a second receiving bore mount secured thereto;
securing a first threaded hole mount onto the first pin;
securing a second threaded hole mount onto the second pin;
inserting a first bolt through a first receiving bore on the first receiving bore mount until the first bolt functionally engages with a second threaded hole on the second threaded hole mount;
inserting a second bolt through a second receiving bore on the second receiving bore mount until the second bolt functionally engages with a first threaded hole on the first threaded hole mount;
rotating the first bolt; and
rotating the second bolt.

19. The method of claim 18 wherein the second pin is inserted in the second rail hole in an opposite direction as the first pin is inserted in the first rail hole.

20. A rail pulling system comprising:
a first and a second pin;
a first and a second bolt;
a first and a second threaded hole;
a first and a second receiving bore;
the first receiving bore is fixedly mounted onto a trailing end of the first pin via a first receiving bore mount,
the second receiving bore is fixedly mounted onto a trailing end of the second pin via a second receiving bore mount;
the receiving bores further comprise substantially smooth inner surfaces defining receiving bore holes;
a first and a second threaded hole mount that mounts the respective first and second threaded hole onto the respective first and second pin;
the first and the second threaded hole mount is shaped to removeably engaged with respective leading ends of the first and the second pins;
the threaded holes further comprise threaded inner surfaces defining threaded hole openings;
the receiving bores are shaped so as to allow a leading end of the bolts to pass through the receiving bores and to engage with a bolt head;
the threaded holes are shaped so as to functionally engage with a leading end of the bolts;
the pins have a cross section measuring 1 inch in diameter;
the bolts have a cross section measuring 1 inch in diameter;
the bolts further comprise a head shaped to be rotated by one of a bit and a socket;
the first and the second threaded holes are of unitary construction with the respective first and second threaded hole mounts; and
the first and the second receiving bores are of unitary construction with the respective first and second receiving bore mounts.
